(19) United States
(12) Patent Application Publication
(10) Pub. No.: US 2014/0212624 A1
(43) Pub. Date: Jul. 31, 2014

(54) FIBER-REINFORCED RESIN MEMBER AND METHOD FOR MANUFACTURING FIBER-REINFORCED RESIN MEMBER

(71) Applicant: Shotaro Ayuzawa, Wako-shi (JP)

(72) Inventor: Shotaro Ayuzawa, Wako-shi (JP)

(73) Assignee: HONDA MOTOR CO., LTD., MINATO-KU, TOKYO (JP)

(21) Appl. No.: 14/240,207

(22) PCT Filed: Jun. 27, 2012
(86) PCT No.: PCT/JP2012/066382

§ 371 Date: Feb. 21, 2014

(30) Foreign Application Priority Data
Sep. 4, 2011 (JP) 2011-192192

(51) Int. Cl. B32B 3/26; B32B 5/26; B32B 37/02

(52) U.S. Cl. CPC B32B 3/266; B32B 37/02; B32B 5/26
USPC 428/137; 156/196

(57) ABSTRACT

A fiber-reinforced resin member is provided in which a mounting hole is formed in a plate material reinforced by embedding a fiber in a thermosetting resin, and another member is fixed to the fiber-reinforced resin member (11) by using a securing member fixed into the mounting hole. An insert member having the mounting hole formed therein is connected to an opening formed in the plate material. The insert member is formed into a tubular shape by impregnating a fiber with a thermosetting resin, and hot pressed together with the plate material by using a mold. Such arrangement does not require drilling the mounting hole in a fiber-reinforced resin member, and also does not require strictly aligning the position of the opening of the plate material with respect to a mounting hole molding pin of the mold when setting the uncured plate material in an interior of the mold.

### TECHNICAL FIELD

The present invention relates to a fiber-reinforced resin member in which a mounting hole into which a securing member is fixed is formed in a plate material reinforced by embedding a fiber in an interior of a thermosetting resin, and a method for manufacturing same.

### BACKGROUND ART

An arrangement is known from Patent Document 1 below in which, in order to secure a suspension member to a cross member made of a carbon fiber-reinforced resin, an insert formed from an aluminum extruded material so as to include an outer peripheral wall, a securing part, and a rib is embedded in the interior of the cross member, and the suspension member is secured to the securing part of the insert by means of a bolt.

An arrangement is also known from Patent Document 2 below in which, when fixing an insert made of an aluminum alloy to a fiber-reinforced resin member by adhesion, two layers, that is a chemical conversion coating and an electrodeposition coating, are formed on an adhering face of the aluminum alloy insert, and the electrodeposition coating is adhered to an adhering face of the fiber-reinforced resin member via an adhesive.

### RELATED ART DOCUMENTS

### Patent Documents

Patent Document 1: Japanese Patent Application Laid-open No. 2009-255799

Patent Document 2: Japanese Patent Application Laid-open No. 2009-248358

### SUMMARY OF THE INVENTION

### Problems to be Solved by the Invention

In the arrangement described in Patent Document 1 above, since the insert, which is formed from the electrically-conductive aluminum extruded material, is directly embedded in the interior of the cross member, which is made of the electrically-conductive carbon fiber-reinforced resin, there is a possibility that when moisture enters between joined faces of the two, electrolytic corrosion will occur and the insert made of aluminum will corrode.

Furthermore, in the arrangement described in Patent Document 2 above, since the fiber-reinforced resin member and the insert made of an aluminum alloy are fixed by adhesion, there is a possibility that unless a sufficient adhesion area is ensured they will peel apart from each other, and if an attempt were made to ensure that there is a sufficient adhesion area the insert would increase in size and the weight would increase.

The most light-weight and simple structure would involve drilling a mounting hole in a fiber-reinforced resin member; fitting a securing member into this mounting hole would enable another member to be fixed to the fiber-reinforced resin member or the fiber-reinforced resin member to be fixed to another member.

However, if a mounting hole is drilled in the fiber-reinforced resin member, not only does the number of processing steps increase to thus cause the cost to go up, but there is also the problem that tool wear would become severe due to the hard carbon fiber or glass fiber.

In order to avoid this problem, consideration could be given to forming a mounting hole in advance in an uncured fiber-reinforced resin member, fitting the mounting hole without a gap around the outer periphery of a mounting hole molding pin provided on a mold when this fiber-reinforced resin member is set in the mold, and in this state closing the mold and carrying out hot press forming, thus molding a fiber-reinforced resin member having a mounting hole. However, if this method were to be employed, not only would it be very troublesome to fit a mounting hole of an uncured fiber-reinforced resin member around the outer periphery of a mounting hole molding pin of a mold, but there would also be the problem that creases would occur in the fiber-reinforced resin member around the mounting hole molding pin, thus degrading the quality.

The present invention has been accomplished in light of the above circumstances, and it is an object thereof to enhance the ease of processing and strength of a mounting hole for a securing member formed in a plate material of a fiber-reinforced resin member.

### Means for Solving the Problems

In order to attain the above object, according to a first aspect of the present invention, there is provided a fiber-reinforced resin member in which a mounting hole into which a securing member is fixed is formed in a plate material reinforced by embedding a fiber in an interior of a thermosetting resin, wherein an insert member having the mounting hole formed therein is connected to an interior of an opening formed in the plate material, the insert member being formed into a tubular shape by impregnating a fiber with a thermosetting resin, and hot pressed together with the plate material by means of a mold.

Further, according to a second aspect of the present invention, in addition to the first aspect, the fiber embedded in the plate material is carbon fiber, and the insert member is a glass fiber-containing SMC material.

Furthermore, according to a third aspect of the present invention, in addition to the first aspect, the fiber embedded in the plate material is carbon fiber, and the insert member is a carbon fiber-containing SMC material.

Moreover, according to a fourth aspect of the present invention, in addition to the first aspect, the fiber embedded in the plate material is carbon fiber, and the insert member is a carbon fiber-containing prepreg material.

Further, according to a fifth aspect of the present invention, in addition to any one of the first to fourth aspects, a surface in contact with the securing member is covered with a glass fiber-containing fiber-reinforced resin sheet.

Furthermore, according to a sixth aspect of the present invention, there is provided a method for manufacturing a fiber-reinforced resin member in which a mounting hole into which a securing member is fixed is formed in a plate material reinforced by embedding a fiber in an interior of a thermosetting resin, the method comprising: a step of layering a plurality of prepregs having an opening in an interior of a mold having a mounting hole molding pin to thus surround an outer periphery of the hole molding pin with the opening; a step of fitting an insert member, formed into a tubular shape by impregnating a fiber with a thermosetting resin, between the opening and the mounting hole molding pin; and a step of hot pressing and curing the prepreg and the insert member by clamping and heating the mold.

### Effects of the Invention

In accordance with the first aspect of the present invention, the fiber-reinforced resin member is one in which a mounting hole is formed in a plate material reinforced by embedding a fiber in the interior of a thermosetting resin, and another member is fixed to the fiber-reinforced resin member or the fiber-reinforced resin member is fixed to another member by means of a securing member fixed into the mounting hole. The insert member having the mounting hole formed therein is connected to the interior of the opening formed in the plate material, and since the insert member is formed by hot pressing in a mold, together with the plate material, a material formed into a tubular shape by impregnating a fiber with a thermosetting resin, not only does it become unnecessary to drill a mounting hole in a fiber-reinforced resin member after molding is completed, thus reducing the number of processing steps, but it also becomes unnecessary to strictly align the position of the opening of the plate material with respect to the mold when setting an uncured plate material in the interior of the mold, thereby greatly improving the ease of operation.

Furthermore, in accordance with the second aspect of the present invention, since the insert member is a glass fiber-containing SMC material, it is possible to avoid stress concentration around the mounting hole by means of the glass fiber, which is relatively easy to stretch. Moreover, since the fiber embedded in the plate material is carbon fiber, if the securing member fixed to the mounting hole were electrically connected to the plate material, there would be a possibility of electrolytic corrosion occurring in the securing member, but since the glass fiber contained in the insert member, with which the securing member is in contact, is a poor conductor, it is possible to prevent the securing member from being electrically connected to the plate material via the insert member, thus suppressing the occurrence of electrolytic corrosion.

Moreover, in accordance with the third aspect of the present invention, since the insert member is a carbon fiber-containing SMC material, it is possible to enhance the strength around the mounting hole by means of the carbon fiber, which has a relatively high tensile strength.

Furthermore, in accordance with the fourth aspect of the present invention, since the insert member is a carbon fiber-containing prepreg, it is possible to enhance the strength around the mounting hole by means of the carbon fiber, which has a relatively high tensile strength.

Moreover, in accordance with the fifth aspect of the present invention, since the face with which the securing member is in contact is covered by a glass fiber-containing fiber-reinforced resin sheet, it is possible to more reliably suppress electrolytic corrosion of the securing member by means of the glass fiber, which is a poor conductor.

Furthermore, in accordance with the sixth aspect of the present invention, the fiber-reinforced resin member is one in which a mounting hole is formed in a plate material reinforced by embedding a fiber in the interior of a thermosetting resin, and another member is fixed to the fiber-reinforced resin member or the fiber-reinforced resin member is fixed to another member by means of a securing member fixed into the mounting hole. Since production of the fiber-reinforced resin member includes a step of layering a plurality of prepregs having an opening in the interior of a mold having a mounting hole molding pin to thus surround the outer periphery of the mounting hole molding pin with the opening, a step of fitting an insert member, formed into a tubular shape by impregnating a fiber with a thermosetting resin, between the opening and the mounting hole molding pin, and a step of hot pressing and curing the prepreg and the insert member by clamping and heating the mold, not only does it become unnecessary to drill a mounting hole in a fiber-reinforced resin member after molding is completed, thus reducing the number of processing steps, but it also becomes unnecessary to strictly align the position of the opening of the plate material with respect to the mounting hole molding pin of the mold when setting an uncured plate material in the interior of the mold, thereby greatly improving the ease of operation.

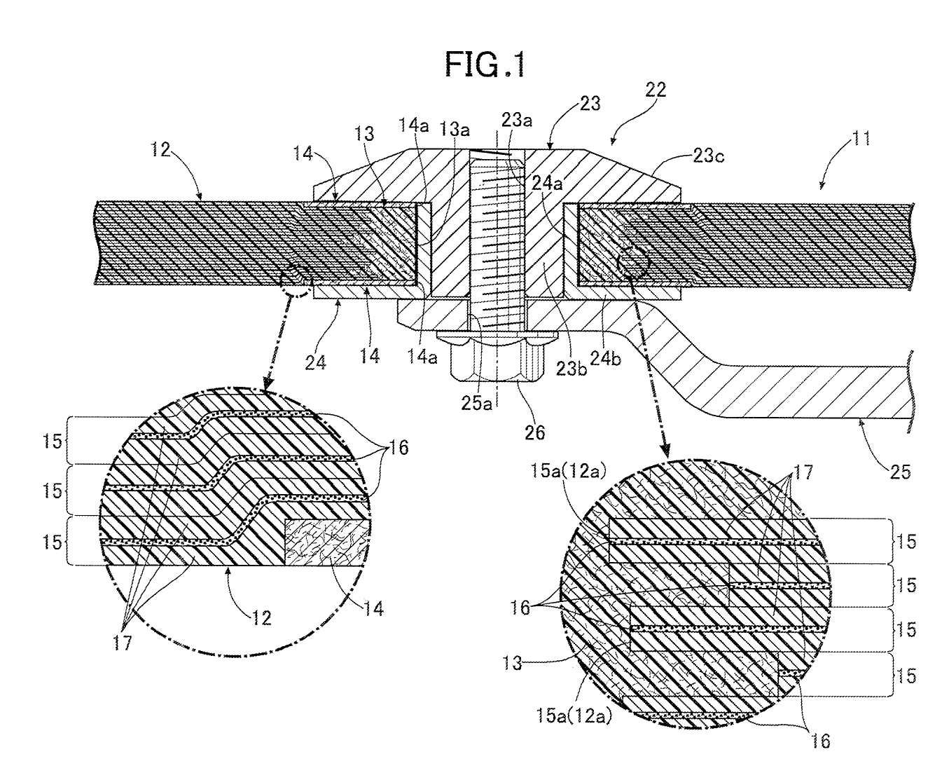

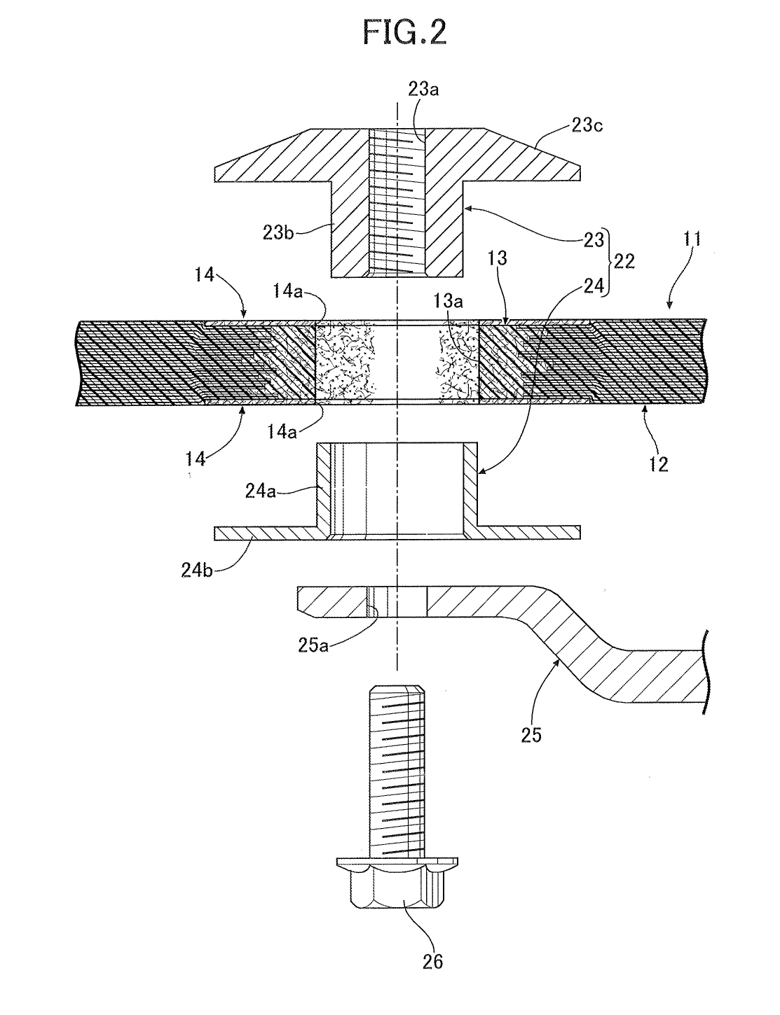

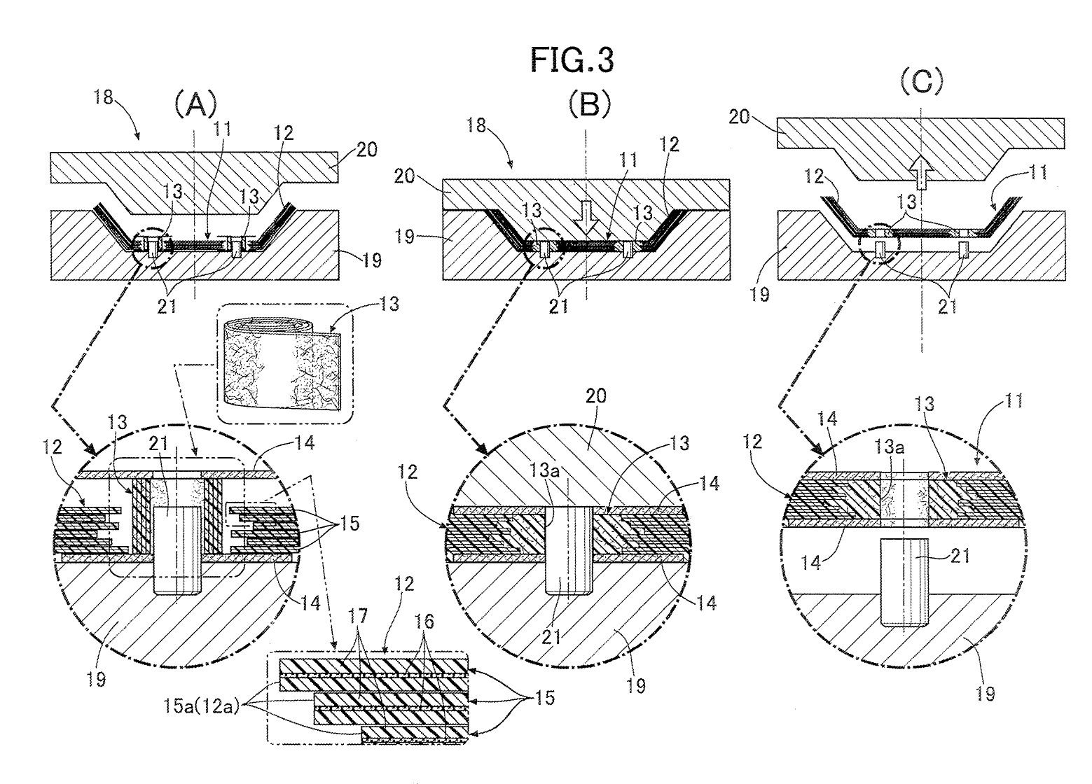

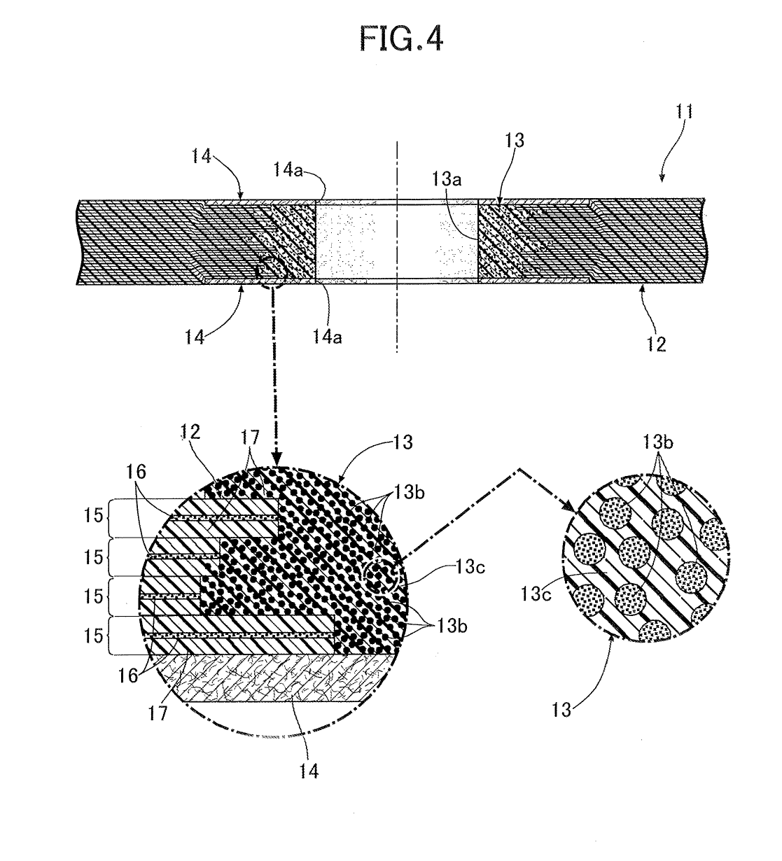

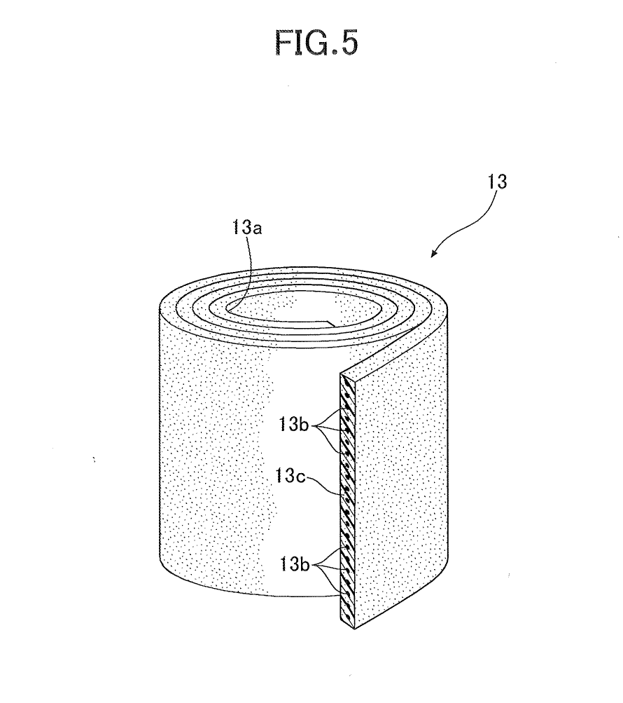

### BRIEF DESCRIPTION OF DRAWINGS

[FIG. 1] FIG. 1 is a sectional view of a fiber-reinforced resin member in an in-use state. (first and second embodiments)

[FIG. 2] FIG. 2 is an exploded view corresponding to FIG. 1. (first and second embodiments)

[FIG. 3] FIG. 3 is a diagram showing steps of producing a fiber-reinforced resin member. (first and second embodiments)

[FIG. 4] FIG. 4 is a sectional view of a fiber-reinforced resin member. (third embodiment)

[FIG. 5] FIG. 5 is a perspective view of an insert member before molding. (third embodiment)

### EXPLANATION OF REFERENCE NUMERALS AND SYMBOLS

12 Plate material

12a Opening

13 Insert member

13a Mounting hole

14 Fiber-reinforced resin sheet

15 Prepreg

15a Opening

16 Fiber

17 Thermosetting resin

18 Mold

21 Mounting hole molding pin

22 Securing member

### MODES FOR CARRYING OUT THE INVENTION

First and second embodiments of the present invention are explained below by reference to FIG. 1 to FIG. 3.

### First and Second Embodiments

As shown in FIG. 1, a member such as for example a subframe of an automobile is molded as a fiber-reinforced resin member 11. The fiber-reinforced resin member 11 is formed from a plate material 12, an insert member 13 disposed in the interior of an opening 12a of the plate material 12, and two annular fiber-reinforced resin sheets 14 and 14 layered so as to extend from upper and lower faces of the insert member 13 to upper and lower faces of the plate material 12. The plate material 12 is formed by layering a plurality of prepregs 15.

The prepreg 15 is a material formed by impregnating a woven fabric or UD (a sheet in which a fiber is aligned in one direction) formed from a fiber 16 such as carbon fiber, glass fiber, or aramid fiber with a semi-cured thermosetting resin 17 (an epoxy resin or a polyester resin), and does not have surface stickiness but has the flexibility to enable it to conform to the shape of a mold. When the plurality of prepregs 15 in a layered state are inserted into the mold and heated to on the order of 130° C., for example, while applying pressure, the thermosetting resin 17 cures, thus giving an autoclave product such as a dry carbon product.

The insert member 13 is formed from an SMC (Sheet Molding Compound). The SMC is a material formed by impregnating a glass fiber sheet with a material in which a filler such as calcium carbonate or another additive has been added to a thermosetting resin such as an unsaturated polyester resin or a vinyl ester resin. By setting the insert member 13, which is formed into a thin plate shape having flexibility, in the interior of a mold and applying pressure and heat so as to cure the unsaturated polyester resin, a fiber-reinforced resin product with any shape can be molded. The insert member 13 prior to being inserted into the mold is formed into a cylindrical shape by for example winding up a band-shaped SMC.

A step of molding the fiber-reinforced resin member 11 is now explained by reference to FIG. 3.

As shown in FIG. 3 (A), a mold 18 for molding the fiber-reinforced resin member 11 is formed from a lower mold 19 and an upper mold 20, and two mounting hole molding pins 21 and 21 for forming mounting holes 13a and 13a in the insert member 13 of the fiber-reinforced resin member 11 are implanted in a cavity of the lower mold 19. The number of mounting hole molding pins 21 and 21 is not limited to two and may be one, or three or more.

First, openings 14a and 14a of the annular fiber-reinforced resin sheets 14 and 14 are fitted around outer peripheries of the two mounting hole molding pins 21 and 21 of the lower mold 19 of the mold 18. Subsequently, the plurality of prepregs 15, which have been cut into a predetermined shape in advance, are layered within the cavity of the lower mold 19. Two openings 15a and 15a are formed in advance in each prepreg 15, and the prepreg 15 is disposed such that the openings 15a and 15a fit loosely onto the outer peripheries of the two mounting hole molding pins 21 and 21.

The diameter of the openings 15a and 15a of the prepreg 15 is sufficiently large relative to the diameter of the mounting hole molding pins 21 and 21, and the operation of fitting the openings 15a and 15a of the prepreg 15 onto the outer peripheries of the mounting hole molding pins 21 and 21 is therefore easy. Furthermore, it is unnecessary to position the openings 15a and 15a of the prepreg 15 relative to the mounting hole molding pins 21 and 21 with good precision, and there is no problem even if steps occur at the edges of the openings 15a of the plurality of prepregs 15. The openings 15a of the plurality of prepregs 15 form the openings 12a and 12a of the plate material 12.

Subsequently, after the cylindrical insert members 13 and 13 are fitted between the openings 12a and 12a of the plate material 12 and the mounting hole molding pins 21 and 21, the annular fiber-reinforced resin sheets 14 and 14 are placed on upper faces of the insert members 13 and 13. In this process, the centers of the openings 14a and 14a of the fiber-reinforced resin sheets 14 and 14 are disposed on axes of the mounting hole molding pins 21 and 21.

Subsequently, as shown in FIG. 3 (B), the upper mold 20 is lowered relative to the lower mold 19, thus carrying out mold clamping. This mold clamping enables each insert member 13 to be clamped between the upper and lower fiber-reinforced resin sheets 14 and 14, be plastically deformed, be pushed outward in the radial direction, and spread to the interior of the opening 12a of the plate material 12 without a gap.

Subsequently, as shown in FIG. 3 (C), when the mold 18 is heated the prepregs 15 and the insert members 13 and 13 are thermally cured and integrated, thereby integrally joining the fiber-reinforced resin sheets 14 to upper and lower faces thereof. The fiber-reinforced resin member 11 thus molded is removed from the mold 18, which is opened by separating the upper mold 20 from the lower mold 19.

When the fiber-reinforced resin member 11 is completed as described above, as shown in FIG. 2, a securing member 22 made of for example an aluminum alloy is fitted into the mounting hole 13a of each insert member 13 of the fiber-reinforced resin member 11. The securing member 22 is formed from a first member 23 and a second member 24, the first member 23 including a shaft portion 23b having a female thread 23a formed on the inner periphery thereof and a circular flange 23c extending from one end of the shaft portion 23b in the radial direction, and the second member 24 including a cylindrical shaft portion 24a and a circular flange 24b extending from one end of the shaft portion 24a in the radial direction.

When press fitting the inner periphery of the shaft portion 24a of the second member 24 around the outer periphery of the shaft portion 23b of the first member 23 in the interior of the mounting hole 13a of the insert member 13, the flange 23c of the first member 23 and the flange 24c of the second member 24 are abutted against the two fiber-reinforced resin sheets 14 and 14, which are layered on upper and lower faces of the fiber-reinforced resin member 11. In this process, due to the tip of the shaft portion 24a of the second member 24 abutting against the lower face of the flange 23c of the first member 23, the gap between the two flanges 23c and 24b is restricted to a gap that is commensurate with the thickness of the fiber-reinforced resin member 11. Therefore, screwing a bolt 26 inserted through a bolt hole 25a of a suspension member 25 into the female thread 23a of the first member 23 enables the suspension member 25 to be strongly fixed to the fiber-reinforced resin member 11 forming the automobile subframe.

As described above, since the mounting holes 13a and 13a of the fiber-reinforced resin member 11 are formed from the insert members 13 and 13, which are inserted into the mold 18 together with the prepregs 15 as a material for the plate material 12, it becomes unnecessary to form the mounting holes 13a and 13a by drilling the fiber-reinforced resin member 11, thus enabling the number of processing steps to be cut. Furthermore, when the prepregs 15 are set in the mold 18, since the diameter of the openings 15a of the prepregs 15 is sufficiently large with respect to the diameter of the mounting hole molding pins 21 and 21, not only does the operation of setting the prepregs 15 become easy, but it is also possible to prevent the prepregs 15 from becoming creased by interference between the openings 15a and the mounting hole molding pins 21 and 21. Even when edges of the openings 15a of the prepregs 15 (that is, the opening 12a of the plate material 12) are nonuniform, since the openings 15a can be filled with the insert member 13, which is compressed and spread in the radial direction within the mold 18, this can instead contribute to strong integration of the plate material 12 and the insert member 13.

Furthermore, the plate material 12 of the fiber-reinforced resin member 11 is an electrically conductive member containing carbon fiber, and when the securing member 22, which is made of metal, comes into direct contact therewith, there is a possibility of electrolytic corrosion occurring on the contacting face of the securing member 22. However, in accordance with the present embodiment, since the fiber-reinforced resin member 11 around the mounting holes 13a and 13a is covered by the glass fiber-containing fiber-reinforced resin sheets 14 and 14, which are electrically nonconductive, it is possible to prevent the flanges 23c and 24b of the securing member 22 from being in contact with the electrically conductive plate material 12, thus avoiding the occurrence of electrolytic corrosion.

Moreover, since glass fiber, which is electrically nonconductive, is used in an SMC (Sheet Molding Compound) for the insert member 13, it is possible to more reliably prevent the occurrence of electrolytic corrosion due to contact between the insert member 13 and the securing member 22. Furthermore, since glass fiber has excellent stretchability compared with carbon fiber, it is possible to alleviate stress concentrated around the mounting hole 13a when a load is applied to the securing member 22.

A second embodiment of the present invention is now explained.

In the first embodiment, glass fiber is used in the SMC for the insert member 13, but in the second embodiment carbon fiber is used in an SMC instead of glass fiber. Since carbon fiber has higher stretching strength compared with glass fiber, it is possible to further enhance the strength around a mounting hole 13a. Since carbon fiber is electrically conductive, electrolytic corrosion more easily occurs in a securing member 22, but this can be dealt with adequately by covering an insert member 13 with fiber-reinforced resin sheets 14 and 14. In this case, it becomes necessary to cover a peripheral wall face of the mounting hole 13a with the glass fiber-containing fiber-reinforced resin sheet.

A third embodiment is now explained by reference to FIG. 4 and FIG. 5.

### Third Embodiment

In the first and second embodiments, an SMC is used as the insert member 13, but in the third embodiment a prepreg is used as an insert member 13. This prepreg, as shown in FIG. 5, is one in which carbon fibers 13b aligned in one direction are embedded in the interior of a band-shaped semi-cured epoxy resin 13c; the insert member 13, which is formed by winding the prepreg into a cylindrical shape, is set in the interior of a mold 18 and subjected to hot press forming together with prepregs 15 of a plate material 12.

In accordance with the third embodiment, as shown in FIG. 4, since in a state in which molding of a fiber-reinforced resin plate material 11 is completed the carpon fibers 13b of the insert member 13 are wound so as to surround a mounting hole 13a, the strength of the mounting hole 13a greatly improves.

Modes for carrying out the present invention are explained above, but the present invention may be modified in a variety of ways as long as the modifications do not depart from the spirit and scope thereof.

For example, the fiber-reinforced resin member 11 of the present invention may be applied to any application in addition to the automobile subframe.

Furthermore, the mounting hole 13a may be used not only in a case where another member is fixed to the fiber-reinforced resin member 11 but also in a case where the fiber-reinforced resin member 11 is fixed to another member.

Moreover, in the embodiments the fiber-reinforced resin sheet 14 is set within the mold 18 and layered on the fiber-reinforced resin member 11, but the fiber-reinforced resin sheet 14 may be layered on the fiber-reinforced resin member 11 when it has been removed from the mold 18.

1. A fiber-reinforced resin member in which a mounting hole into which a securing member is fixed is formed in a plate material reinforced by embedding a fiber in an interior of a thermosetting resin, wherein
an insert member having the mounting hole formed therein is connected to the plate material, the insert member is formed by impregnating a fiber with a thermosetting resin, the plate material is formed by layering a plurality of component members, the diameter of an opening provided in each of the component members is sufficiently larger than the diameter of the mounting hole, and the opening is filled with the insert member in a state in which edges of the openings of the component members are nonuniform.

2. The fiber-reinforced resin member according to claim 1, wherein the fiber embedded in the plate material is carbon fiber, and the insert member is a glass fiber-containing SMC material.

3. The fiber-reinforced resin member according to claim 1, wherein the fiber embedded in the plate material is carbon fiber, and the insert member is a carbon fiber-containing SMC material.

4. The fiber-reinforced resin member according to claim 1, wherein the fiber embedded in the plate material is carbon fiber, and the insert member is a carbon fiber-containing prepreg material.

5. The fiber-reinforced resin member according to claim 1, wherein a surface in contact with the securing member is covered with a glass fiber-containing fiber-reinforced resin sheet.

6. A method for manufacturing a fiber-reinforced resin member in which a mounting hole into which a securing member is fixed is formed in a plate material reinforced by embedding a fiber in an interior of a thermosetting resin, the method comprising:
a step of layering in an interior of a mold a plurality of prepregs having an opening that is larger than a mounting hole molding pin so as to fit onto the mounting hole molding pin to thus surround an outer periphery of the mounting hole molding pin with edges of the openings, the edges being in a nonuniform state;
a step of fitting an insert member, formed into a tubular shape by impregnating a fiber with a thermosetting resin, between the opening and the mounting hole molding pin; and
a step of hot pressing and curing the prepreg and the insert member by clamping and heating the mold so as to fill the openings, in a state in which the edges thereof are nonuniform, with the insert member, which has been compressed and spread in a radial direction within the mold.

7. The fiber-reinforced resin member according to claim 2, wherein a surface in contact with the securing member is covered with a glass fiber-containing fiber-reinforced resin sheet.

8. The fiber-reinforced resin member according to claim 3, wherein a surface in contact with the securing member is covered with a glass fiber-containing fiber-reinforced resin sheet.

9. The fiber-reinforced resin member according to claim 4, wherein a surface in contact with the securing member is covered with a glass fiber-containing fiber-reinforced resin sheet.
